(19) United States
(12) Patent Application Publication
(10) Pub. No.: US 2016/0224121 A1
(43) Pub. Date: Aug. 4, 2016

(54) FEEDBACK METHOD AND SYSTEM FOR INTERACTIVE SYSTEMS

(71) Applicant: POINTGRAB LTD., Hod Hasharon (IL)

(72) Inventor: ERAN EILAT, GIVATAYIM (IL)

(21) Appl. No.: 14/917,964

(22) PCT Filed: Sep. 10, 2014
(86) PCT No.: PCT/IL2014/000046

§ 371 Date: Mar. 10, 2016

Related U.S. Application Data
(60) Provisional application No. 61/875,711, filed on Sep. 10, 2013.

(30) Foreign Application Priority Data
Sep. 10, 2013 (IL) 228332

(51) Int. Cl. G06F 3/01; G06T 7/00; G06F 3/03

(52) U.S. Cl. CPC G06F 3/017; G06F 3/0304; G06T 7/0042; G06T 7/0065; G06F 3/011

(57) ABSTRACT

A computer vision based interactive system includes a device to be controlled by a user based on image analysis, an imager in communication with the device and a feedback indicator configured to create an indicator FOV which correlates with the FOV of the imager for providing indication to the user that the user is within the imager FOV.

### FIELD OF THE INVENTION

This invention relates to the field of interactive systems. More specifically, the invention provides a feedback method and system to improve the reliability of computer vision based interactive systems.

### BACKGROUND

The need for more convenient, intuitive and portable input devices increases, as computers and other electronic devices become more prevalent in our everyday life.

Recently, human gesturing, such as hand gesturing, has been suggested as a user interface input tool in which a hand gesture is detected by a camera and is translated into a specific command. Gesture recognition enables humans to interface with machines and interact naturally without any mechanical appliances. The development of alternative computer interfaces (forgoing the traditional keyboard and mouse), video games and remote controlling are only some of the fields that may implement human gesturing techniques.

Recognition of a hand gesture may require identification of an object as a hand and tracking the identified hand to detect a posture or gesture that is being performed.

Typically, a device being controlled by gestures includes a user interface, such as a display, allowing the user to interact with the device through the interface and to get feedback regarding his operations. However, only a limited number of devices and home appliances include displays or other user interfaces that allow a user to interact with them.

Additionally, in a home environment there is usually more than one device. In a multi device environment feedback to the user, so that the user knows which device he is communicating with, may be especially important.

Currently, for those devices that do not have a display there is no means of providing feedback to the user, especially feedback regarding whether or not the user is within the camera's field of view (FOV). Even devices that do possess a display are often restricted from displaying feedback to the user regarding the user's location since visual feedback may interfere with other visual content being displayed by the device. For example, a TV set may have a camera for gesture control of the TV set, however, a visual display of the camera images will interfere with the TV viewing experience.

Thus, when interacting with many existing devices a user may get no feedback regarding his interaction with the device, leading to a frustrating and incomplete user experience.

### SUMMARY

Embodiments of the present invention provide methods and systems for giving a user feedback from a system, for example, feedback regarding whether or not the user resides within a FOV of a sensor, such as an image sensor.

According to one embodiment a computer vision based interactive system may include a device to be controlled by a user based on image analysis; an imager in communication with the device, said imager having a FOV and said imager to capture images of the FOV; and a feedback indicator configured to create an indicator FOV which correlates with the imager FOV for providing indication to the user that the user is within the imager FOV.

The system may further include a processor in communication with the imager to perform image analysis of the images of the FOV and to generate a user command to control the device based on the image analysis results. The processor may identify a user's hand from the images of the FOV and to generate a user command based on the shape and/or movement of the user's hand. The processor may apply a shape detection algorithm on the images of the FOV to identify the user's hand.

According to one embodiment the feedback indicator includes a visual element and a visual limiting structure, the visual limiting structure being configured to limit visibility of the visual element to a desired aperture.

The visual element may include a passive indicator or an active indicator.

The visual limiting structure may include an optical element or a structure which includes a construct encompassing the visual element. The construct may have an aperture configured to create a FOV which correlates with the imager FOV. The construct may include light absorbing material.

According to one embodiment the system may include a sensor to sense the presence of the user within the indicator FOV and to activate an indicator to signal to the user.

According to one embodiment the feedback indicator is embedded within the device.

According to other embodiments of the invention there is provided an indicator for providing feedback to a user, the indicator comprising a visual element and a visual limiting structure, the visual limiting structure configured to create a desired FOV for the visual element.

According to one embodiment the desired FOV is a FOV which correlates to a FOV of a camera used to image the user.

The indicator may include a passive visual element or an active visual element.

The visual limiting structure may include an optical element or a construct encompassing the visual element. The construct may have an aperture configured to create the desired FOV.

In one embodiment the invention provides a method which includes providing an imager for imaging a FOV; providing a feedback indicator having a FOV which correlates with the FOV of the imager; and providing control of a device based on image analysis of images from the imager.

### BRIEF DESCRIPTION OF THE FIGURES

The invention will now be described in relation to certain examples and embodiments with reference to the following illustrative figures so that it may be more fully understood. In the drawings:

FIGS. 1A and 1B are schematic front view and top view illustrations of a system and indicator according to embodiments of the invention;

FIG. 2 is a schematic illustration of an indicator according to embodiments of the invention; and

FIG. 3 is a schematic illustration of a method for enabling operation of an interactive computer vision based system according to embodiments of the invention.

### DETAILED DESCRIPTION OF THE INVENTION

Methods according to embodiments of the invention may be implemented in a system which includes a device to be operated by a user and one or more image sensors or cameras which are in communication with a processor. The image sensor(s) obtains image data of a FOV (typically a field of view which includes the user) and sends it to the processor to perform image analysis and to generate user commands to the device based on the image analysis results, thereby controlling the device based on computer vision.

Different embodiments are disclosed herein. Features of certain embodiments may be combined with features of other embodiments; thus certain embodiments may be combinations of features of multiple embodiments,

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

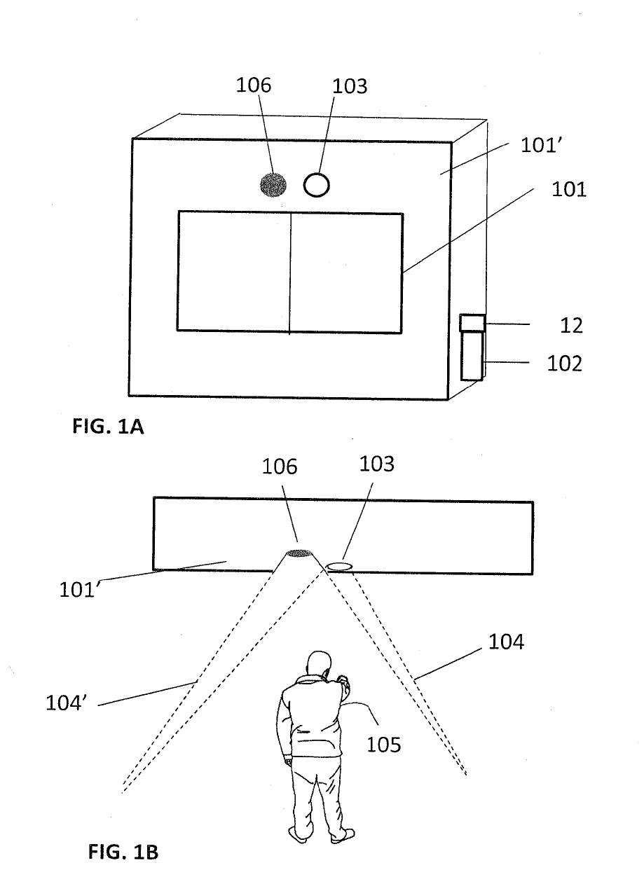

An exemplary system, according to one embodiment of the invention, is schematically described in FIGS. 1A and B however other systems may carry out embodiments of the present invention.

A system 100, according to embodiments of the invention, includes a device 101 (a light switch in this example) and an image sensor 103 which may be associated with the device 101 and with a processor 102 and memory 12.

The image sensor 103 has a FOV 104 which may be determined by parameters of the imager and other elements such as optics or an aperture placed over the imager 103. The imager 103 sends the processor 102 image data of the FOV 104 to be analyzed by processor 102. FOV 104 may include a user 105, a user's hand or part of a user's hand (such as one or more fingers) or another object held or operated by the user 105 for controlling the device 101.

Typically, image signal processing algorithms such as object detection and/or shape detection algorithms may be run in processor 102 or in another associated processor or unit. According to one embodiment a user command is generated by processor 102 or by another processor, based on the image analysis, and is sent to the device 101. According to some embodiments the image processing is performed by a first processor which then sends a signal to a second processor in which a user command is generated based on the signal from the first processor.

Processor 102 may include, for example, one or more processors and may be a central processing unit (CPU), a digital signal processor (DSP), a microprocessor, a controller, a chip, a microchip, an integrated circuit (IC), or any other suitable multi-purpose or specific processor or controller.

Memory unit(s) 12 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

The device 101 may be any electronic device or home appliance that can accept user commands, e.g., light switch, air conditioner, stove, TV, DVD player, PC, set top box (STB) or streamer and others. “Device” may include a housing or other parts of a device.

The processor 102 may be integral to the imager 103 or may be a separate unit. Alternatively, the processor 102 may be integrated within the device 101. According to other embodiments a first processor may be integrated within the imager and a second processor may be integrated within the device.

The communication between the imager 103 and processor 102 and/or between the processor 102 and the device 101 may be through a wired or wireless link, such as through infrared (IR) communication, radio transmission, Bluetooth technology and/or other suitable communication routes.

According to one embodiment a standard 2D camera such as a webcam or other standard video capture device may be used. A camera may include a CCD or CMOS or other appropriate chip.

Processor 102 may perform methods according to embodiments discussed herein by, for example, executing software or instructions stored in memory 12. According to some embodiments image data may be stored in processor 102, for example, in a cache memory. Processor 102 can apply image analysis algorithms, such as motion detection and shape recognition algorithms to identify and further track an object such as the user's hand. Thus the processor 102 may identify a user's hand (or other object) from images of a FOV and may generate a user command based on the shape and/or movement of the user's hand (or other object). A shape detection algorithm may be applied on the images of the FOV to identify the user's hand (or other object) by identifying its shape. In one example, once a hand is identified as a hand (e.g., by its shape), the hand may be tracked and different shapes and/or movements of the hand may be translated to different user commands to the device.

According to embodiments of the invention shape recognition or detection algorithms may include, for example, an algorithm which calculates Haar-like features in a Viola-Jones object detection framework. Tracking the user's hand may be done by using optical flow methods or other appropriate tracking methods.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

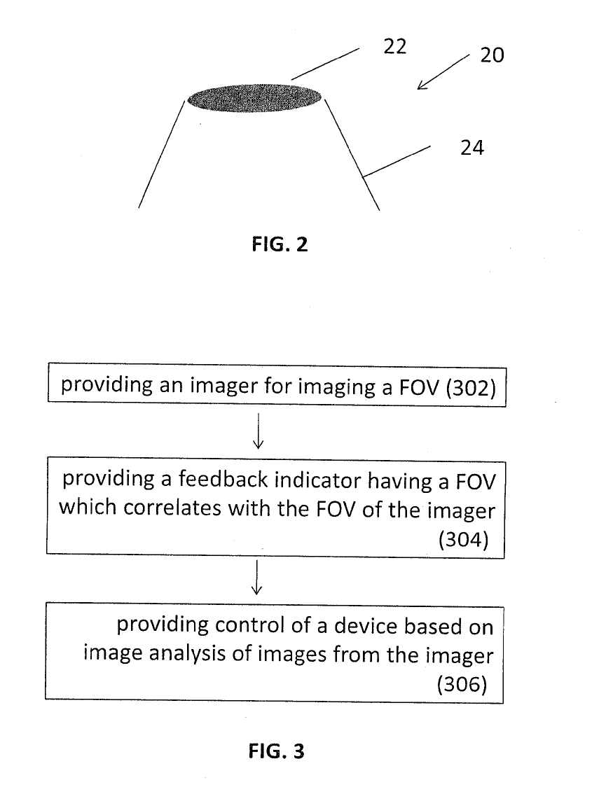

According to one embodiment a feedback indicator 106 is included in the system. The feedback indicator 106 (an example of which is schematically illustrated in FIG. 2) may include a visual limiting structure configured to create a FOV 104′ which correlates with (e.g., overlaps or has some overlap with) the imager FOV 104.

According to one embodiment the imager 103 and feedback indicator 106 are both attached to or embedded within the device 101 in proximity to each other. A user meaning to operate the device (e.g., turn the device on or oft) using hand gestures or postures will typically be positioned in view of the imager 103, e.g., in front of device 101. The design of the feedback indicator 106 is such that a user must stand in the FOV 104′ of the feedback indicator 106 in order to see the indicator 106. Since the FOV 104′ correlates with the imager FOV 104, if the user is positioned within FOV 104′, he will also be within FOV 104. Thus, the feedback indicator according to embodiments of the invention provides the user with feedback relating the user's ability to operate the device. If the user cannot see the feedback indicator 106, then the user has indication that he is not in FOV 104′ (and therefore not in FOV 104) and he knows he should change his position in order to be able to touchlessly operate a device. Thus the feedback indicator may provide indication to the user that the user is within the imager FOV.

According to one embodiment the feedback indicator dictates positioning of the user within the imager FOV.

The feedback indicator 106 may be located on, attached to or embedded within the device 101. According to one embodiment, schematically illustrated in FIG. 1B, the indicator 106 or part of the indicator may be embedded within a frame (e.g., housing) 101′ of the device 101. The indicator or part of the indicator may be embedded into a cone shaped niche in the frame 101′ or the indicator may be encompassed within a cone shaped wall, the niche or cone having an aperture which creates a FOV 104′ which correlates to the sensor FOV 104.

An indicator according to one embodiment of the invention is schematically illustrated in FIG. 2.

An indicator 20 for providing feedback to a user may include a visual element 22 and a visual limiting structure 24 which may be configured to create a desired FOV for the visual element 22. The desired FOV for the visual element 22 is typically a FOV from which a user may see the visual element 22 and which correlates with a camera FOV, the camera typically being associated with the indicator, for example, as described above.

The visual element 22 may be a passive element (such as a colored symbol, drawing, engraving, sticker etc.) or an active element such as a light source (LED or other suitable illumination source).

According to one embodiment a sensor to sense the presence of the user within the indicator FOV may be included in a system and may be used to activate the feedback indicator to signal to the user. For example, a system may include a feedback indicator having an LED light source as a visual element. The system may further include a sensor such as a photodetector to detect obstruction of a light beam from the LED. Other sensors may be used. If a user is positioned within the FOV of the feedback indicator the photodetector may detect the presence of the user and may then communicate to the LED to flicker or otherwise change its illumination to give the user feedback, namely letting the user know that he is in the feedback indicator FOV (and accordingly in the imager FOV).

According to one embodiment visual limiting structure 24 is attached or otherwise connected to the visual element 22 such that it limits the visibility of the visual element 22 to a specific, desired aperture, which typically correlate (e.g., overlaps or partially overlaps) with a FOV of a camera.

The visual limiting structure 24 may be an optical element such as a lens which creates a desired FOV. According to another embodiment the optical element is or includes a construct encompassing the visual element 22. The construct may be cone shaped and may have an aperture which correlates with a desired FOV (e.g., FOV of a camera). According to one embodiment, the visual limiting structure 24 may include (e.g., by coating or spraying) light absorbing material to further limit vision of the visual element to a desired aperture.

According to one embodiment a method for enabling operation of an interactive computer vision based system includes dictating positioning of a user in relation to a camera of the system. According to one embodiment such positioning is dictated by providing a feedback indicator such as described above and requiring the user to position himself such that he can see the indicator before or while operating the system.

According to one embodiment a method for enabling operation of an interactive computer vision based system is schematically illustrated in FIG. 3 and may include providing an imager for imaging a FOV (302) which includes a user's hand (or another object such as another part of the user's body); providing a feedback indicator having a FOV which correlates with the FOV of the imager (304) for providing indication to the user that the user is within the imager FOV; and providing control of a device based on image analysis of images from the imager (306). Image analysis may include analyzing images from the imager e.g., to identify movement of a hand (hand gesture) and/or a shape of the hand (hand posture) and control of the device may be based on the identified hand gesture and/or posture.

The hand gesture or posture may be identified by using shape recognition algorithms to identify a shape of a hand and/or by using motion detection algorithms and/or by using other appropriate image analysis algorithms.

1-21. (canceled)

22. A computer vision based interactive system comprising:
a device to be controlled by a user based on image analysis;
an imager in communication with the device, said imager having a FOV and said imager to capture images of the FOV; and
a feedback indicator configured to create an indicator FOV which correlates with the imager FOV for providing indication to the user that the user is within the imager FOV.

23. The system of claim 22 comprising a processor in communication with the imager to perform image analysis of the images of the FOV and to generate a user command to control the device based on the image analysis results.

24. The system of claim 23 wherein the processor is to identify a shape of an object in the images of the FOV and to generate a user command based on the identified shape.

25. The system of claim 22 wherein the feedback indicator comprises a visual element and a visual limiting structure, the visual limiting structure being configured to limit visibility of the visual element to a desired aperture.

26. The system of claim 25 wherein the visual element comprises a passive indicator.

27. The system of claim 25 wherein the visual element comprises an active indicator.

28. The system of claim 25 wherein the visual limiting structure comprises an optical element.

29. The system of claim 25 wherein the visual limiting structure comprises a construct encompassing the visual element.

30. The system of claim 29 wherein the construct has an aperture configured to create a FOV which correlates with the imager FOV.

31. The system of claim 29 wherein the construct comprises light absorbing material.

32. The system of claim 22 comprising a sensor to sense the presence of the user within the indicator FOV and to activate the feedback indicator to signal to the user.

33. The system of claim 22 wherein the feedback indicator is embedded within the device.

34. An indicator for providing feedback to a user, the indicator comprising:
a visual element; and
a visual limiting structure,
the visual limiting structure configured to create a FOV for the visual element, said FOV correlating to a FOV of a camera used to image the user.

35. The indicator of claim 34 wherein the indicator comprises a passive visual element.

36. The indicator of claim 34 wherein the indicator comprises an active visual element.

37. The indicator of claim 34 wherein the visual limiting structure comprises an optical element.

38. The indicator of claim 34 wherein the visual limiting structure comprises a construct encompassing the visual element.

39. The indicator of claim 38 wherein the construct has an aperture configured to create the FOV for the visual element.

40. A method for enabling operation of a computer vision based system, the method comprising:
providing a feedback indicator having a FOV which correlates with a FOV of an imager providing images to be analyzed.

41. The method of claim 40 comprising providing control of a device based on the analysis of the images.
